(19) United States
(12) Patent Application Publication
(10) Pub. No.: US 2023/0295359 A1
(43) Pub. Date: Sep. 21, 2023

(54) Method Of Producing Acrylic Copolymer, Dispersant, And Ink Jet Composition

(71) Applicant: SEIKO EPSON CORPORATION, Tokyo (JP)

(72) Inventors: Harunobu KOMATSU, Matsumoto (JP); Koji HORIBA, Atsugi (JP)

(21) Appl. No.: 18/159,262

(22) Filed: Jan. 25, 2023

(30) Foreign Application Priority Data
Jan. 26, 2022 (JP) 2022-010498

(51) Int. Cl. C08F 220/30; C09D 11/38; C09D 11/107; C08F 220/06; C08F 212/08

(52) U.S. Cl. CPC C08F 220/301; C08F 212/08; C08F 220/06; C09D 11/107; C09D 11/38; C08F 2438/03

(57) ABSTRACT

A method of producing an acrylic copolymer of the present disclosure is a method of producing an acrylic copolymer that contains a RAFT agent, a polymerization initiator, and a monomer including at least an acrylic monomer, in which a mass ratio of an amount of the polymerization initiator to be charged to an amount of the RAFT agent to be charged is preferably 3.0 or greater and 18.0 or less. A mass ratio of an amount of the monomer to be charged to the amount of the RAFT agent to be charged is 100 or greater and 1000 or less. A mass ratio of an amount of the monomer to be charged to the amount of the polymerization initiator to be charged is 50 or greater and 300 or less.

The present application is based on, and claims priority from JP Application Serial Number 2022-010498, filed Jan. 26, 2022, the disclosure of which is hereby incorporated by reference herein in its entirety.

### BACKGROUND

### 1. Technical Field

The present disclosure relates to a method of producing an acrylic copolymer, a dispersant, and an ink jet composition.

### 2. Related Art

An acrylic resin has been widely used in various fields, and particularly, an acrylic copolymer having a structure derived from an acrylic monomer has been used in order to obtain desired characteristics.

In radical polymerization, a RAFT agent has been used for the purpose of obtaining a resin with a small molecular weight dispersity (that is, the ratio of the weight-average molecular weight to the number average molecular weight) and a sharp molecular weight distribution.

For example, there has been an attempt to use an acrylic resin synthesized by a reaction using a RAFT agent and having a sharp molecular weight distribution, particularly, an acrylic resin having a molecular weight dispersity of 1.8 or less for the purpose of providing an aqueous ink composition having an excellent print density while maintaining pigment dispersibility (for example, see JP-A-2010-95591).

However, when an acrylic copolymer is synthesized by the reaction using a RAFT agent, it is necessary to sufficiently reduce the reaction rate in order to decrease the molecular weight dispersity of the acrylic copolymer.

Therefore, the reaction takes a long time and the monomer consumption is reduced, and thus the efficiency of synthesis is significantly decreased. Further, since the RAFT agent is an expensive reagent, the cost of synthesis increases due to the use of a large amount of the RAFT agent.

### SUMMARY

The present disclosure has been made to solve the above-described problems, and can be realized as the following aspects.

According to an aspect of the present disclosure, there is provided a method of producing an acrylic copolymer that contains a RAFT agent, a polymerization initiator, and a monomer including at least an acrylic monomer, in which a mass ratio of an amount of the polymerization initiator to be charged to an amount of the RAFT agent to be charged is 3.0 or greater and 18.0 or less.

In the method of producing an acrylic copolymer according to the aspect of the present disclosure, a mass ratio of an amount of the monomer to be charged to the amount of the RAFT agent to be charged is 100 or greater and 1000 or less.

In the method of producing an acrylic copolymer according to the aspect of the present disclosure, a mass ratio of an amount of the monomer to be charged to the amount of the polymerization initiator to be charged is 50 or greater and 300 or less.

In the method of producing an acrylic copolymer according to the aspect of the present disclosure, a molecular weight dispersity of the acrylic copolymer is 2.0 or greater and 3.0 or less.

Further, according to another aspect of the present disclosure, there is provided a dispersant including an acrylic copolymer produced by the method of producing an acrylic copolymer according to the aspect of the present disclosure.

Further, according to still another aspect of the present disclosure, there is provided an ink jet composition including an acrylic copolymer produced by the method of producing an acrylic copolymer according to the aspect of the present disclosure.

### DESCRIPTION OF EXEMPLARY EMBODIMENTS

Hereinafter, suitable embodiments of the present disclosure will be described in detail.

### 1. Method of Producing Acrylic Copolymer

First, a method of producing an acrylic copolymer of the present disclosure will be described.

The method of producing an acrylic copolymer of the present disclosure is a method of producing an acrylic copolymer that contains a RAFT agent, a polymerization initiator, and a monomer including at least an acrylic monomer. Further, a mass ratio of an amount of the polymerization initiator to be charged to an amount of the RAFT agent to be charged is 3.0 or greater and 18.0 or less.

In this manner, it is possible to provide a method of producing an acrylic copolymer which enables synthesis of an acrylic copolymer having a sufficiently small molecular weight dispersity with high productivity.

Further, the acrylic copolymer obtained in the above-described manner has, for example, excellent characteristics as a dispersant. Therefore, for example, the acrylic copolymer can be suitably applied to an ink jet composition required such that a coloring material, which is a dispersoid, has high dispersion stability, a change in particle size distribution of the coloring material is small even when stored for a long period of time or stored under severe conditions, and the coloring material has excellent redispersibility even when the coloring material is deposited.

On the contrary, satisfactory results cannot be obtained when the above-described conditions are not satisfied.

For example, when the mass ratio of the amount of the polymerization initiator to be charged to the amount of the RAFT agent to be charged is less than the lower limit described above, the conversion ratio from the monomer to the acrylic copolymer is decreased and the productivity of the acrylic copolymer is significantly reduced.

Further, when the mass ratio of the amount of the polymerization initiator to be charged to the amount of the RAFT agent to be charged is greater than the upper limit described above, the molecular weight dispersity of the acrylic copolymer is difficult to sufficiently decrease, and the dispersion stability or the like of the dispersoid cannot be sufficiently improved in a case where the acrylic copolymer is used as a dispersant. Further, the conversion ratio from the monomer to the acrylic copolymer is decreased, and the productivity of the acrylic copolymer is also reduced.

As described above, the mass ratio of the amount of the polymerization initiator to be charged to the amount of the RAFT agent to be charged may be 3.0 or greater and 18.0 or less, preferably 4.0 or greater and 17.8 or less, more preferably 5.0 or greater and 17.5 or less, and still more preferably 10.0 or greater and 17.2 or less.

In this manner, the above-described effects are more significantly exhibited.

### 1-1. Monomer

In the method of producing an acrylic copolymer of the present disclosure, a plurality of kinds of monomers including at least an acrylic monomer are used as the monomer. Further, in the method of producing an acrylic copolymer of the present disclosure, only an acrylic monomer may be used or monomers other than the acrylic monomer may be used in combination as raw materials of the acrylic copolymer.

Examples of the acrylic monomer include a hydrophobic acrylic monomer having an aromatic ring or a (meth)acrylic acid alkyl ester structure in a molecule and a hydrophilic acrylic monomer containing a carboxylic acid group or a sulfonic acid group in a molecule.

Examples of the hydrophobic acrylic monomer include phenoxyethyl (meth)acrylate and (meth)acrylic acid alkyl ester such as methyl (meth)acrylate, ethyl (meth)acrylate, propyl (meth)acrylate, butyl (meth)acrylate, pentyl (meth)acrylate, or hexyl (meth)acrylate. Among these, phenoxyethyl (meth)acrylate is preferable.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

Examples of the hydrophilic acrylic monomer include (meth)acrylic acid, 2-acrylamido-2-methylpropane sulfonic acid, and salts thereof.

Examples of the monomers other than the acrylic monomer include hydrophobic monomers, for example, vinyl aromatic compounds such as styrene and 2-vinylnaphthalene, and hydrophilic monomers such as vinylsulfonic acid, (meth)allylsulfonic acid, vinyl carboxylate, and salts thereof.

Among these, styrene is preferable as the hydrophobic monomer other than the acrylic monomer.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

The proportion of the hydrophobic monomers in all the monomers used for production of the acrylic copolymer is preferably 30% by mass or greater and 85% by mass or less, more preferably 40% by mass or greater and 75% by mass or less, and still more preferably 50% by mass or greater and 70% by mass or less.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

The proportion of the hydrophilic monomers in all the monomers used for production of the acrylic copolymer is preferably 15% by mass or greater and 70% by mass or less, more preferably 25% by mass or greater and 60% by mass or less, and still more preferably 30% by mass or greater and 50% by mass or less.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

When (meth)acrylic acid is used to produce the acrylic copolymer, the proportion of the (meth)acrylic acid in all the monomers used for production of the acrylic copolymer is preferably 5% by mass or greater and 70% by mass or less, more preferably 8% by mass or greater and 60% by mass or less, and still more preferably 10% by mass or greater and 50% by mass or less.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

When 2-acrylamido-2-methylpropane sulfonic acid is used to produce the acrylic copolymer, the proportion of the 2-acrylamido-2-methylpropane sulfonic acid in all the monomers used for production of the acrylic copolymer is preferably 5% by mass or greater and 40% by mass or less, more preferably 10% by mass or greater and 35% by mass or less, and still more preferably 15% by mass or greater and 30% by mass or less.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

When phenoxyethyl (meth)acrylate is used to produce the acrylic copolymer, the proportion of the phenoxyethyl (meth)acrylate in all the monomers used for production of the acrylic copolymer is preferably 30% by mass or greater and 85% by mass or less, more preferably 40% by mass or greater and 75% by mass or less, and still more preferably 50% by mass or greater and 70% by mass or less.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

When styrene is used to produce the acrylic copolymer, the proportion of the styrene in all the monomers used for production of the acrylic copolymer is preferably 30% by mass or greater and 85% by mass or less, more preferably 40% by mass or greater and 75% by mass or less, and still more preferably 50% by mass or greater and 70% by mass or less.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

The mass ratio of the amount of the monomer to be charged to the amount of the RAFT agent to be charged described below in detail is preferably 100 or greater and 1000 or less, more preferably 200 or greater and 980 or less, and still more preferably 300 or greater and 950 or less.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

The mass ratio of the amount of the monomer to be charged to the amount of the polymerization initiator to be charged described below in detail is preferably 50 or greater and 300 or less, more preferably 51 or greater and 200 or less, and still more preferably 52 or greater and 100 or less.

In this manner, the amount of residual monomers after the reaction can be reduced. That is, the conversion ratio from the monomer to the acrylic copolymer can be further increased. Further, the amount of the RAFT agent to be used can be reduced, and thus the cost of synthesis can be reduced.

### 1-2. RAFT Agent

The RAFT agent is, for example, a polymerization control agent used for a reversible addition-cleavage chain transfer polymerization method.

For example, various known RAFT agents such as a dithioester compound, a xanthate compound, a trithiocarbonate compound, and a dithiocarbamate compound can be used as the RAFT agent.

Among such examples, 3-benzylsulfanylthiocarbonylsulfanylpropionic acid or a 2-{[(2-carboxyethyl)sulfanylthiocarbonyl]sulfanyl}propanoic acid is preferable as the RAFT agent.

In this manner, the molecular weight dispersity of the acrylic copolymer to be obtained can be further decreased, and the productivity of the acrylic copolymer can be further improved.

### 1-3. Polymerization Initiator

Examples of the polymerization initiator include an azo compound, an organic peroxide, and a persulfate, and one or two or more kinds selected from these can be used in combination. Among these, from the viewpoints of being safe to handle and being unlikely to cause side reactions during radical polymerization, an azo compound is preferable.

Specific examples of the azo compound include 2,2′-azobis(isobutyronitrile), 2,2′-azobis(2,4-dimethylvaleronitrile), 2,2′-azobis(4-methoxy-2,4-dimethylvaleronitrile), dimethyl-2,2′-azobis(2-methylpropionate), 2,2′-azobis(2-methylbutyronitrile), 1,1′-azobis(cyclohexane-1-carbonitrile), 2,2′-azobis[N-(2-propenyl)-2-methylpropionamide], and 2,2′-azobis(N-butyl-2-methylpropionamide), and one or two or more kinds selected from these can be used in combination. Among these, 2,2′-azobis(isobutylnitrile) is preferable.

### 1-4. Solvent

The polymerization reaction in the production of the acrylic copolymer may be performed by bulk polymerization or the like, but a liquid phase reaction carried out by dissolving the above-described components in a solvent is preferable as the polymerization reaction.

Examples of the solvent used in the polymerization reaction include an aromatic compound such as benzene, toluene, xylene, or anisole, an ester compound such as methyl acetate, ethyl acetate, propyl acetate, or butyl acetate, a ketone compound such as acetone or methyl ethyl ketone, and dimethyl formamide, acetonitrile, dimethyl sulfoxide, and alcohol, and one or two or more kinds selected from these can be used in combination.

Among these, dimethyl formamide or isopropyl alcohol is preferable as the solvent.

In this manner, the synthesis reaction of the acrylic copolymer can be more suitably promoted, the molecular weight dispersity of the acrylic copolymer to be obtained can be more decreased, and the productivity of the acrylic copolymer can be further improved.

The mass ratio of the amount of the solvent to be charged to the amount of the monomer to be charged is preferably 1.4 or greater and 5.0 or less and more preferably 1.6 or greater and 3.0 or less.

In this manner, the above-described effects are more significantly exhibited.

### 1-5. Other Components

In the polymerization reaction in the production of the acrylic copolymer, other components in addition to the components described above may be used. Hereinafter, such components are also referred to as “other components” in the section 1-5.

Examples of the other components include a pH adjuster such as triethanolamine or ammonia, and a chain transfer agent.

For example, an alkylthiol compound having 2 or more and 20 or less carbon atoms can be used as the chain transfer agent.

Here, the content of water in the composition that undergoes the polymerization reaction is preferably 2.0% by mass or less, more preferably 1.0% by mass or less, and still more preferably 0.5% by mass or less.

The content of other components in the composition that undergoes the polymerization reaction is preferably 6.0% by mass or less and more preferably 5.0% by mass or less.

### 1-6. Conditions for Reaction

The polymerization reaction in the production of the acrylic copolymer may be carried out by using the RAFT agent, the polymerization initiator, and the monomer including at least an acrylic monomer, but it is preferable that the following conditions be satisfied.

For example, when the polymerization reaction is carried out, it is preferable that the reaction be carried out by heating the composition, and the heating temperature during the reaction is not particularly limited, but is preferably 40° C. or higher and 90° C. or lower, more preferably 45° C. or higher and 85° C. or lower, and still more preferably 50° C. or higher and 80° C. or lower.

Further, the reaction time of the polymerization reaction is not particularly limited, but is preferably 3 hours or longer and 36 hours or shorter, more preferably 4 hours or longer and 24 hours or shorter, and still more preferably 5 hours or longer and 20 hours or shorter.

Further, the polymerization reaction may be carried out as a one-step reaction or two- or more-step reaction.

The acrylic copolymer synthesized in the above-described manner may be purified as necessary.

### 1-7. Conditions and the Like for Acrylic Copolymer

The weight-average molecular weight of the acrylic copolymer obtained in the above-described manner ispreferably 10,000 or greater and 60,000 or less and morepreferably 12,000 or greater and 70,000 or less.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

The number average molecular weight of the acrylic copolymer obtained in the above-described manner ispreferably 4,000 or greater and 40,000 or less and more preferably 6,000 or greater and 25,000 or less.

In this manner, the dispersion stability of a dispersoid and the storage stability or the like of a dispersion liquid can be further improved when the acrylic copolymer is used as a dispersant. Particularly, in a case where the acrylic copolymer is applied to an ink jet composition containing a coloring material as a dispersoid, the redispersibility of the coloring material can be further improved even when the coloring material is deposited, and the jetting stability by an ink jet method can be further improved.

The molecular weight dispersity of the acrylic copolymer obtained in the above-described manner, that is, the number obtained by dividing the weight-average molecular weight Mw of the acrylic copolymer by the number average molecular weight Mn of the acrylic copolymer is preferably 2.0 or greater and 3.0 or less, more preferably 2.1 or greater and 2.9 or less, and still more preferably 2.2 or greater and 2.8 or less.

In this manner, the amount of residual monomers after the reaction can be further reduced. That is, the conversion ratio from the monomer to the acrylic copolymer can be further increased. Further, the amount of the RAFT agent to be used can be reduced, and thus the cost of synthesis can be reduced.

### 2. Dispersant

Next, the dispersant of the present disclosure will be described.

The dispersant of the present disclosure contains the acrylic copolymer produced by the method of producing an acrylic copolymer described above.

In this manner, it is possible to provide a dispersant in which the dispersibility of the dispersoid is excellent. More specifically, it is possible to provide a dispersant having excellent characteristics required for a dispersant, for example, high dispersion stability of the dispersoid, a small change in particle size distribution of the dispersoid even when the dispersoid is stored for a long period of time or stored under severe conditions, and excellent redispersibility of the dispersoid even when the dispersoid is deposited.

The dispersant of the present disclosure may be formed of only the acrylic copolymer produced by the method of producing an acrylic copolymer described above or may contain other components in addition to the acrylic copolymer.

Examples of such components include known dispersant components, that is, dispersant components other than the acrylic copolymer.

### 3. Ink Jet Composition

Next, an ink jet composition of the present disclosure will be described.

The ink jet composition of the present disclosure contains the acrylic copolymer produced by the method of producing an acrylic copolymer described above.

In this manner, it is possible to provide an ink jet composition in which the dispersion stability of the dispersoid such as a coloring material is high, a change in particle size distribution of the dispersoid is small even when the dispersoid is stored for a long period of time or stored under severe conditions, the jetting stability by the ink jet method is excellent, and the redispersibility of the solid content is excellent even when the solid content is deposited.

In the present specification, the concept “ink jet composition” includes an ink to be jetted by the ink jet method as well as a stock solution used to prepare the ink. In other words, the ink jet composition of the present disclosure may be directly jetted by the ink jet method or may be jetted by the ink jet method after a treatment such as dilution or the like. Examples of the ink jet method include an on-demand method such as a charge deflection method, a continuous method, a piezo method, and a Bubble Jet (registered trademark) method.

The ink jet composition of the present disclosure is not limited as long as the composition contains the acrylic copolymer produced by the method of producing an acrylic copolymer described above, and typically contains a coloring material as a dispersoid and a liquid-like dispersion medium when the acrylic copolymer functions as a dispersant.

The content of the acrylic copolymer in the ink jet composition according to the present disclosure is preferably 0.5% by mass or greater and 15.0% by mass or less and more preferably 0.8% by mass or greater and 12.5% by mas or less.

Particularly, when the ink jet composition according to the present disclosure serves as an ink, the content of the acrylic copolymer in the ink jet composition is preferably 0.05% by mass or greater and 5.0% by mass or less and more preferably 0.1% by mass or greater and 2.0% by mass or less.

Further, when the ink jet composition according to the present disclosure serves as a stock solution used to prepare an ink, the content of the acrylic copolymer in the ink jet composition is preferably 2.5% by mass or greater and 15.0% by mass or less and more preferably 4.0% by mass or greater and 12.5% by mass or less.

Hereinafter, components other than the acrylic copolymer among the constituent components of the ink jet composition according to the present disclosure will be described.

### 3-1. Coloring Material

Examples of the coloring material contained in the ink jet composition according to the present disclosure include acid dyes, reactive dyes, disperse dyes, sublimation dyes, and pigments. Among these, disperse dyes are preferable.

The disperse dyes are not particularly limited, and specific examples thereof are as described below.

Examples of yellow disperse dyes include C.I. Disperse Yellow 3, 4, 5, 7, 9, 13, 23, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 160, 162, 163, 164, 165, 179, 180, 182, 183, 184, 186, 192, 198, 199, 202, 204, 210, 211, 215, 216, 218, 224, 227, 231, and 232.

Examples of orange disperse dyes include C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, and 142.

Examples of red disperse dyes include C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, and 328.

Examples of violet disperse dyes include C.I. Disperse Violet 1, 4, 8, 23, 26, 27, 28, 31, 33, 35, 36, 38, 40, 43, 46, 48, 50, 51, 52, 56, 57, 59, 61, 63, 69, and 77.

Examples of green disperse dyes include C.I. Disperse Green 9.

Examples of brown disperse dyes include C.I. Disperse Brown 1, 2, 4, 9, 13, and 19.

Examples of blue disperse dyes include C.I. Disperse Blue 3, 7, 9, 14, 16, 19, 20, 26, 27, 35, 43, 44, 54, 55, 56, 58, 60, 62, 64, 71, 72, 73, 75, 79, 81, 82, 83, 87, 91, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, and 333.

Examples of black disperse dyes include C.I. Disperse Black 1, 3, 10, and 24.

In the present disclosure, for example, one or two or more kinds selected from the above-described coloring materials can be used in combination.

When the content of the coloring material in the ink jet composition according to the present disclosure is defined as XC [% by mass] and the content of the acrylic copolymer in the ink jet composition according to the present disclosure is defined as XD [% by mass], it is preferable to satisfy a relationship of 0.05 ≤ XD/XC ≤ 1.00, more preferable to satisfy a relationship of 0.08 ≤ XD/XC ≤ 0.72, and still more preferable to satisfy a relationship of 0.10 ≤ XD/XC ≤ 0.60.

In this manner, the dispersion stability of the coloring material in the ink jet composition, the storage stability of the ink jet composition, the redispersibility of the coloring material when the coloring material of the ink jet composition is deposited, and the like can be further improved while the content of the coloring material in the ink jet composition is sufficiently increased.

### 3-2. Dispersion Medium

Examples of the dispersion medium contained in the ink jet composition according to the present disclosure include water and a water-soluble organic solvent such as glycerin, propylene glycol, or 2-pyrrolidone, and one or two or more kinds selected from these can be used in combination.

The content of the dispersion medium contained in the ink jet composition is preferably 30.0% by mass or greater and 95.0% by mass or less, more preferably 35.0% by mass or greater and 90.0% by mass or less, and still more preferably 40.0% by mass or greater and 85.0% by mass or less.

### 3-3. Other Components

The ink jet composition according to the present disclosure may contain other components in addition to the components described above. Hereinafter, such components are also referred to as “other components” in the section 3-3.

Examples of such components include a pH adjuster such as triethanolamine or ammonia, a chelating agent, an antiseptic or antifungal agent, a rust inhibitor, a flame retardant, a surfactant, an antioxidant, a violet absorbing agent, an oxygen absorbing agent, a dissolution assistant, and a penetrant.

Examples of the chelating agent include an ethylenediaminetetraacetate. Further, examples of the antiseptic or antifungal agent include sodium benzoate, sodium pentachlorophenol, sodium 2-pyridinethiol-1-oxide, sodium sorbate, sodium dehydroacetate, 1,2-dibenzisothiazolin-3-one, and 4-chloro-3-methylphenol. Further, examples of the rust inhibitor include benzotriazole.

As the antiseptic or antifungal agent, for example, a compound having an isothiazoline ring structure in a molecule can be suitably used.

Various surfactants such as anionic surfactants, cationic surfactants, and non-ionic surfactants can be used as the surfactant.

The content of the other components is preferably 3.0% by mass or less and more preferably 2.0% by mass or less.

Further, the lower limit of the content of the other components is 0% by mass.

### 3-4. Physical Properties and the Like of Ink Jet Composition

The viscosity of the ink jet composition according to the present disclosure at 25° C. is preferably 2 mPa ·s or greater and 10 mPa ·s or less, more preferably 3 mPa ·s or greater and 8 mPa ·s or less, and still more preferably 4 mPa ·s or greater and 6 mPa ·s or less.

In this manner, the jetting stability of the ink jet composition according to the present disclosure using the ink jet method is further improved.

Further, the viscosity can be measured by reading the viscosity at 25° C. when the shear rate is 10 [s⁻¹] using a viscoelastic tester (for example, VISCO 6800, manufactured by Atago Co., Ltd.).

Hereinbefore, suitably embodiments of the present disclosure have been described, but the present disclosure is not limited thereto.

For example, in the embodiments described above, a case where the acrylic copolymer is used as a dispersant and a case where the acrylic copolymer is used as a constituent component of the ink jet composition have been mainly described, but the applications of the acrylic copolymer are not particularly limited thereto and the acrylic copolymer may be used for applications other than the applications described above.

Further, the method of producing an acrylic copolymer according to the present disclosure may have configurations other than the configurations described above.

### EXAMPLES

Next, specific examples of the present disclosure will be described.

### 4. Production of Acrylic Copolymer

### Example 1

First, 40 parts by mass of phenoxyethyl (meth)acrylate (PEA) as a monomer, 40 parts by mass of acrylic acid (AA) as a monomer, 20 parts by mass of 2-acrylamido-2-methylpropane sulfonic acid (ATBS) as a monomer, 0.11 parts by mass of 3-benzylsulfanylthiocarbonylsulfanylpropionic acid (BSPA) as a RAFT agent, and 1.87 parts by mass of 2,2′-azobis(isobutyronitrile) (AIBN) as a polymerization initiator were dissolved in 2.0 parts by mass of dimethylformamide (DMF) in a flask.

Next, the inside of the flask charged with each of the above-described components was substituted with nitrogen, and the mixture was heated and stirred at 75° C. for 16 hours and allowed to be naturally cooled until the next day.

Next, water was added to the reaction solution, the solution was stirred and subjected to ultrafiltration, a mixed solvent of water and isopropyl alcohol (IPA) at a mass ratio of 10:1 was added to the obtained filtrate, and an operation of performing ultrafiltration was repeated 5 times.

The filtrate obtained in the above-described manner was freezed with liquid nitrogen and freeze-dried by a vacuum dryer, thereby obtaining an acrylic copolymer. Examples 2 to 7

Each acrylic copolymer was produced in the same manner as in Example 1 except that the kind of each monomer component, the amount of each monomer component used, the amount of the polymerization initiator used, the kind of the RAFT agent, and the amount of the RAFT agent used were set as listed in Table 1.

### Comparative Examples 1 to 4

Each acrylic copolymer was produced in the same manner as in Example 1 except that the kind of each monomer component, the amount of each monomer component used, the amount of the polymerization initiator used, the kind of the RAFT agent, and the amount of the RAFT agent used were set as listed in Table 2.

### 5. Measurement on Acrylic Copolymer

The number average molecular weight and the weight-average molecular weight of the acrylic copolymer of each example and each comparative example were acquired by performing measurement using gel permeation chromatography (GPC), and the molecular weight dispersity thereof was acquired from the results. Further, the conversion ratio from the monomer to the acrylic copolymer of each example and each comparative example was acquired from the proton ratio obtained by measurement using ¹H-NMR, and the conversion ratio was evaluated according to the following criteria. It can be said that the productivity of the acrylic copolymer is more excellent as the conversion ratio in the reaction for a predetermined time increases. A satisfactory level was evaluated as A.

A: The conversion ratio was 90% or greater.

B: The conversion ratio was 80% or greater and less than 90%.

C: The conversion ratio was less than 80%.

### 6 Production of Ink Jet Composition

Each ink jet composition was prepared in the following manner by using the acrylic copolymer of each example and each comparative example as a dispersant, which had been produced in the section 4.

First, a 1 L eggplant-shaped flask was set, 15 parts by mass of the acrylic copolymer obtained in the above-described manner and 70 parts by mass of pure water were added to the flask, and a Dimroth condenser was attached to the flask. Thereafter, the mixture was stirred by a stirrer and heated at 80° C. Here, triethanolamine was added to the solution until the pH thereof reached 7.6, and pure water was added thereto until the total amount thereof reached 100 parts by mass. The solution was cooled to 25° C., and the dissolved aqueous solution was obtained as a varnish solution.

Next, 50 parts by mass of the varnish solution, 15 parts by mass of C.I. Disperse Yellow 232 as a water-insoluble coloring material, and 35 parts by mass of pure water were added to the flask and pulverized in a bead mill for 1 hour, thereby obtaining a coloring material dispersion liquid containing 7.5% by mass of the acrylic copolymer and 15.0% by mass of the coloring material.

Next, 50.0 parts by mass of pure water, 3.0 parts by mass of 1,2-butanediol, 10.0 parts by mass of 1,2-diethylene glycol, 1.0 parts by mass of a carboxymethyl cellulose sodium salt (manufactured by FUJIFILM Wako Pure Chemical Corporation), and 0.3 parts by mass of a silicone-based surfactant (BYK-348, manufactured by BYK Japan K.K.) were added to 20 parts by mass of the coloring material dispersion liquid, pure water was added to the solution such that the total amount thereof reached 100 parts by mass, and the resulting solution was stirred. In this manner, an ink jet composition was obtained.

The viscosity of the ink jet composition of each example at 25° C., which had been obtained in the above-described manner, was a value in a range of 2 mPa ·s or greater and 10 mPa ·s or less. Further, the viscosity was measured under a condition of a shear rate of 10 [s⁻¹] using a viscoelastic tester (VISCO 6800, manufactured by Atago Co., Ltd.).

### 7. Evaluation on Ink Jet Composition

First, 30 mL of each ink jet composition obtained in each example and each comparative example was added to a predetermined container and allowed to stand in a temperature environment of 60° C. for 5 days.

Thereafter, the average particle diameter of the coloring material contained in each coloring material dispersion liquid after standing in a temperature environment of 60° C. for 5 days by performing measurement using an aperture of 50 µm with a coulter counter method particle size distribution measuring machine (TA-II type, manufactured by COULTER ELECTRONICS, INC.), and the evaluation was performed according to the following criteria. It can be said that the dispersion stability of the coloring material and the storage stability of the coloring material dispersion liquid are more excellent as the rate of increase in the average particle diameter decreases. A satisfactory level was evaluated as A.

A: The rate of increase in the average particle diameter was less than 10%.

B: The rate of increase in the average particle diameter was 10% or greater and less than 30%.

C: The rate of increase in the average particle diameter was 30% or greater.

The evaluation results are collectively listed in Table 1 and Table 2 together with the components used to produce the acrylic copolymer of each example and each comparative example, the conditions for the molecular weight of the obtained acrylic copolymer, and the like. Further, in the tables, phenoxyethyl (meth)acrylate is denoted as “PEA”, acrylic acid is denoted as “AA”, 2-acrylamido-2-methylpropane sulfonic acid is denoted as “ATBS”, styrene is denoted as “ST”, 3-benzylsulfanylthiocarbonylsulfanylpropionic acid is denoted as “BSPA”, 2-{[(2-carboxyethyl)sulfanylthiocarbonyl]sulfanyl}propanoic acid is denoted as “CSPA”, 2,2′-azobis(isobutyronitrile) is denoted as “AIBN”, the weight-average molecular weight is denoted as Mw, and the number average molecular weight is denoted as Mn.

TABLE 1

| | | | | | | | | |
|---|---|---|---|---|---|---|---|---|
| | | Example 1 | Example 2 | Example 3 | Example 4 | Example 5 | Example 6 | Example 7 |
| Amount of monomer used [Parts by mass] | PEA | 40 | 40 | 40 | 50 | 50 | | |
| | AA | 40 | 40 | 40 | 50 | 50 | 40 | 40 |
| | ATBS | 20 | 20 | 20 | | - | 20 | 20 |
| | ST | - | - | - | - | - | 40 | 40 |
| Amount of RAFT agent used [Parts by mass] | BSPA | 0.11 | 0.15 | 0.30 | 0.12 | 0.14 | - | - |
| | CSPA | - | - | - | - | - | 0.15 | 0.15 |
| Amount of polymerization initiator used [Parts by mass] | AIBN | 1.87 | 1.75 | 1.74 | 1.82 | 1.73 | 1.82 | 1.82 |
| Amount of polymerization initiator used/amount of RAFT agent used | | 17.0 | 11.7 | 5.8 | 15.2 | 12.4 | 17.5 | 12.1 |
| Amount of monomer used/amount of RAFT agent used | | 909 | 667 | 333 | 833 | 714 | 909 | 667 |
| Amount of monomer used/amount of polymerization initiator used | | 53 | 57 | 57 | 55 | 58 | 52 | 55 |
| Mn | | 19096 | 19014 | 18198 | 13446 | 17290 | 19224 | 17868 |
| Mw | | 55189 | 49105 | 43571 | 38557 | 38386 | 53250 | 41454 |
| Dispersity | | 2.89008 | 2.58257 | 2.39427 | 2.86754 | 2.22013 | 2.76998 | 2.32001 |
| Conversion ratio | | A | A | A | A | A | A | A |
| Change in particle size | | A | A | A | A | A | A | A |

TABLE 2

| | | | | | |
|---|---|---|---|---|---|
| | | Comparative Example 1 | Comparative Example 2 | Comparative Example 3 | Comparative Example 4 |
| Amount of monomer used [Parts by mass] | PEA | 40 | 50 | - | - |
| | AA | 40 | 50 | 40 | 40 |
| | ATBS | 20 | - | 20 | 20 |
| | ST | - | - | 40 | 40 |
| Amount of RAFT agent used [Parts by mass] | BSPA | 0.09 | 0.08 | - | - |
| | CSPA | - | - | 0.09 | 0.90 |
| Amount of polymerization initiator used [Parts by mass] | AIBN | 1.80 | 1.80 | 1.77 | 2.00 |
| Amount of polymerization initiator used/amount of RAFT agent used | | 20.0 | 22.5 | 19.7 | 2.2 |
| Amount of monomer used/amount of RAFT agent used | | 1111 | 1250 | 1111 | 111 |
| Amount of monomer used/amount of polymerization initiator used | | 56 | 56 | 56 | 50 |
| Mn | | 14526 | 15862 | 10241 | 8000 |
| Mw | | 46483 | 68843 | 69741 | 19200 |
| Dispersity | | 3.19999 | 4.34012 | 6.80998 | 2.4 |
| Conversion ratio | | B | B | B | C |
| Change in particle size | | B | C | C | A |

As listed in Table 1 and Table 2, excellent results were obtained in the present disclosure, but satisfactory results were not obtained in the comparative examples.

Further, 30 mL of each ink jet composition obtained in each example and each comparative example was added to a predetermined container and allowed to stand in a temperature environment of 60° C. for 5 days, and the viscosity thereof at 25° C. when the shear rate reached 10 [s⁻ ¹] was acquired using a viscoelastic tester (MCR-300, manufactured by Physica). As a result, it was confirmed that the change in viscosity of the ink jet composition of each example was sufficiently small immediately after the production of the ink jet composition.

Further, each ink jet composition obtained in each example and each comparative example was dropped on slide glass, dried, and solidified, the slide glass was immersed in a sample bottle filled with ink water while being sufficiently careful not to stir the ink water, and the behavior of redispersion of the solid material was visually observed. As a result, it was confirmed that the solid material was suitably dispersed in the ink water in the ink jet composition of each example. Based on this result, it was found that the redispersibility of the solid content in the ink jet composition of each example was excellent.

What is claimed is:

1. A method of producing an acrylic copolymer that contains a RAFT agent, a polymerization initiator, and a monomer including at least an acrylic monomer,
wherein a mass ratio of an amount of the polymerization initiator to be charged to an amount of the RAFT agent to be charged is 3.0 or greater and 18.0 or less.

2. The method of producing an acrylic copolymer according to claim 1,
wherein a mass ratio of an amount of the monomer to be charged to the amount of the RAFT agent to be charged is 100 or greater and 1000 or less.

3. The method of producing an acrylic copolymer according to claim 1,
wherein a mass ratio of an amount of the monomer to be charged to the amount of the polymerization initiator to be charged is 50 or greater and 300 or less.

4. The method of producing an acrylic copolymer according to claim 1,
wherein a molecular weight dispersity of the acrylic copolymer is 2.0 or greater and 3.0 or less.

5. A dispersant comprising:
an acrylic copolymer produced by the method according to claim 1.

6. An ink jet composition comprising:
an acrylic copolymer produced by the method according to claim 1.
